(19) United States
(12) Patent Application Publication
(10) Pub. No.: US 2009/0223873 A1
(43) Pub. Date: Sep. 10, 2009

(54) SCREENING APPARATUS FOR A CONTAMINATED FIBROUS SUSPENSION AND ITS USE

(76) Inventors: Wolfgang Mueller, Weingarten (DE); Andreas Steidele, Ravensburg (DE); Gert Gottschalk, Ravensburg (DE); Roland Reinhold, Ravensburg (DE); Wolfgang Mannes, Ravensburg-Bavendorf (DE)

Correspondence Address: TAYLOR & AUST, P.C., P.O. Box 560, 142. S Main Street, Avilla, IN, 46710, US

(21) Appl. No.: 12/419,472

(22) Filed: Apr. 7, 2009

Related U.S. Application Data
(63) Continuation of application No. PCT/EP2007/007964, filed on Sep. 13, 2007.

(30) Foreign Application Priority Data
Nov. 30, 2006 (DE) 10 2006 055 316.0

(51) Int. Cl. B03B 7/00

(52) U.S. Cl. 209/17

(57) ABSTRACT

The screening apparatus according to the invention is used for processing contaminated fibrous suspension, such as is produced during the preparation of waste paper. It has a housing (1) with a screen (3) which divides off an accepts chamber (2) from housing (1). A rotor (4) can be moved along close to the screen (3), by which the latter is kept free and, in addition, a rotational flow is produced. The housing (1) has a main part (7), which is cylindrical and of which the center is at an oblique angle (α) to the axis (12) of the rotor (4) which is between 1 and 60°, preferably between 5 and 25°. The typical position of use of this apparatus is the upright arrangement.

### CROSS REFERENCE TO RELATED APPLICATIONS

This is a continuation of PCT application No. PCT/EP2007/007964, entitled “SCREENING APPARATUS FOR A CONTAMINATED FIBROUS SUSPENSION AND ITS USE”, filed Sep. 13, 2007, which is incorporated herein by reference.

### BACKGROUND OF THE INVENTION

1. Field of the Invention

The invention relates to a screening apparatus for contaminated fibrous suspensions.

2. Description of the Related Art

An object of such a screening apparatus is to get undesired contaminants out of an aqueous fibrous suspension which, for example, can be obtained from waste paper. As is known, in addition to the desired fibrous materials, waste paper contains a more or less large quantity of contraries, which must not get into the paper. As a rule, a plurality of separating processes is required in order to remove the various types of contraries in the different sections of the preparation process. In many cases, the occurrence of blockages of the preparation system by contraries can be forestalled only by flushing cycles being set up, which understandably can lead to loading of the preparation operation, to quantity surges and to fiber losses.

At the start of the stock preparation, the raw materials are usually mixed with water in a pulper and comminuted to such an extent that they can be pumped out of the pulper as a suspension. Even if, in many cases, pre-cleaning is carried out in the pulper, a considerable quantity of contraries still remain in the suspension that are pumped out and get into the apparatus used for the preparation.

In the scientific article, “Erfahrungen mit einem System zur Stofflöserentsorgung” [Experiences with a system for pulper waste disposal] by Hans-Bernhard Winterstein, which appeared in DAS PAPIER vol. 5, 1993, pages 236 to 239, a waste disposal machine having a screen plate at the top is described. The inlet into this machine is oriented downwards, specifically directly in the direction towards the heavy fraction sluice. Lightweight fractions, in particular of plastic foils, accumulate in the housing of the waste disposal apparatus and are flushed out cyclically. To this end, the contents are diluted with washing water until the washing water consistency is approximately reached.

German Patent Document DE 198 25 669 A1 shows a screening apparatus for pulping and sorting waste paper, which likewise contains a flat screen located at the top, which is kept free by a rotor. The feed into the housing is carried out tangentially. At the bottom, there is a contraries outlet leading obliquely downwards and having a sluice.

What is needed in the art is a screening apparatus with which the contraries can be sorted out successfully and operationally reliably. The intention is for the greatest possible range of contraries to be covered. The screening apparatus is in particular to be suitable for pulping specks and pieces of paper.

### SUMMARY OF THE INVENTION

In an embodiment of the present invention, the rotor movement produces a rotational flow which has an axis of rotation concentric with the rotor axis. This rotational flow in the case of the subject-matter of the invention is not fitted concentrically in the housing but at an oblique angle. It is beneficial if, in addition, an eccentric arrangement of rotor and housing is chosen.

The screening apparatus according to an embodiment of the invention is capable of retaining contraries in the housing with the aid of the screen and of removing them from the fibrous suspension. As compared with the prior art, it has the advantage of improving the pulping of specks and paper pieces, also the separation of coatings and printing inks. In addition, lower wear is possible, since there is barely any risk left that heavy fractions will stay for a long time on a circulation path similar to a circle in the housing.

### BRIEF DESCRIPTION OF THE DRAWINGS

The invention and its advantages will be explained by using drawings, in which:

FIG. 1 shows a screening apparatus that according to an embodiment of the present invention, sectioned in a side view; and

FIG. 2 shows schematics relating to the use of the screening apparatus according to the invention in waste paper preparation.

Corresponding reference characters indicate corresponding parts throughout the several views. The exemplifications set out herein illustrate one embodiment of the invention and such exemplifications are not to be construed as limiting the scope of the invention in any manner.

### DETAILED DESCRIPTION OF THE INVENTION

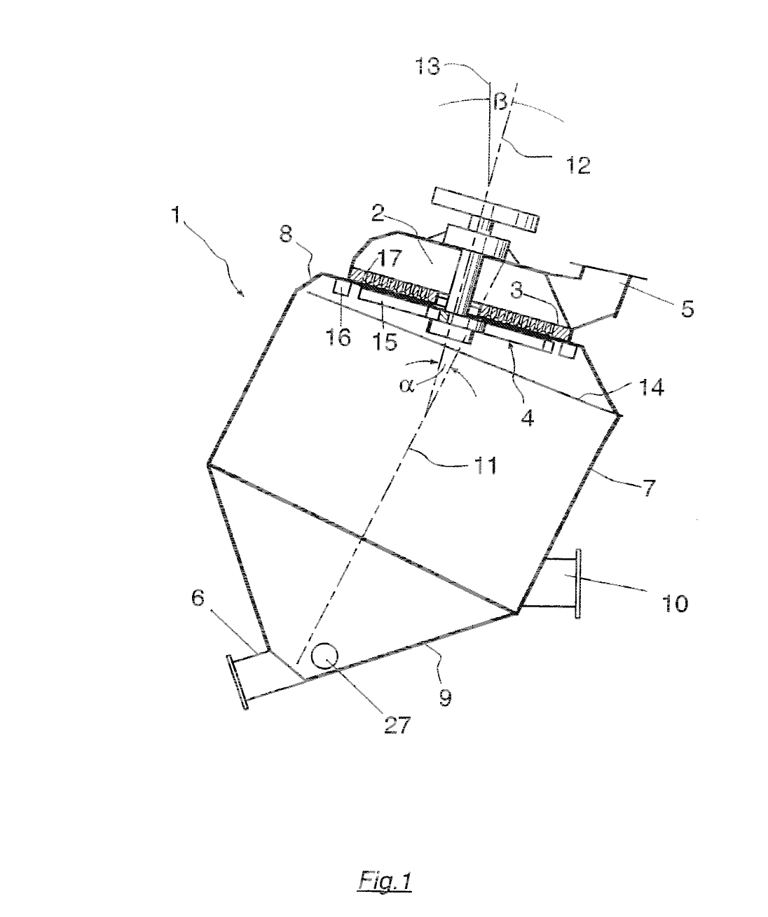

Referring now to the drawings, and more particularly to FIG. 1, there is shown a screening apparatus of the present invention in a typically upright position of use, although it could also be arranged horizontally or in another orientation. It contains a housing 1, which includes a main part 7, a conical adjoining part 8 located above it and a conical part 9 located below main part 7. The internal volume of main part 7 is considerably more than 30% or even more than half the total internal housing volume. Main part 7 has a cylindrical shape with a centerline 11 which, in relation to axis 12 of rotor 4, is arranged at an oblique angle α, which can be chosen between 1° and 60°, being illustrated here about 12°. Angle α preferably lies between 5° and 25°. Adjoining part 8 includes a truncated cone which is concentric with axis 12 and widens at the bottom and which adjoins screen 3 at the top and, the bottom of the cone adjoins main part 7 with a transition 14. Transition 14 runs at right angles to center line 11 of main part 7 and is therefore intersected obliquely by the truncated cone. As a result, there is an eccentricity between main part 7 and the truncated cone.

In the position of use of the apparatus, axis 12 can be upright with respect to vertical axis 13 at an angle β which lies between 0° and 30°, and preferably between 10° and 20°, here it is at 15°. Arranged in adjoining part 8 of housing 1 and concentrically with its centerline 12 is a rotor 4, which is rotatingly driven by a drive set located above, but not shown. Rotor 4 is used both to generate a rotational flow and also for the purpose of keeping screen 3, situated on the upper part of housing 1, free of blockages, for which reason rotor 4 is moved along close to the feed side of screen 3. Screen 3 divides the interior of housing 1 off from the accepts chamber 2 located above, from which the stock accumulated therein can be led out through an accepts outlet 5. Screen 3 is a planar disc provided with screen openings 17 but can also have the form of a flat truncated cone. In the lower part of housing 1 there is an outlet opening 6 leading obliquely downwards for the contraries. It is beneficial to terminate housing 1 at the bottom towards the outlet opening 6 in such a way that any heavy fractions that have reached the bottom are able to slide out of conical part 9 into outlet opening 6. In order to keep this region free of deposits, the addition of flushing water through a flushing water connection 27 is provided.

At one end of main part 7, rotor 4 is spaced therefrom at a minimum spacing. The spacing is at most 50% of the diameter of rotor 4.

As a rule, the screening apparatus will be operated with positive pressure, so that the contraries emerge automatically. In this case, the positive pressure can regulate the quantity of contraries drawn off. However, it is also possible to provide the contraries outlet 6 with a shut-off element, not shown, to open and close it cyclically. It is also contemplated that a metering device can be included which conveys a specific quantity continuously out of the interior without any blockages.

As already mentioned, there is the possibility of both cleaning and also further pulping of the fibrous suspension fed in, via an inlet connector 10, with particular advantage in the same apparatus. For instance, it is expedient, in the screening apparatus of the type described here, to perform further comminution of the solid material contained in the suspension, in order to improve the ability to sort the material. In this case, it is necessary to draw a balance between the damage which arises as a result of the comminution or the contraries and the benefit which can be achieved from the higher level of separation of contraries and fibrous webs. This consideration also includes the size of the screen opening 17 chosen in screen 3. In the cases in which further comminution of defibring of the materials found in the suspension is desired, the result is a very simple possible way of implementing this. Specifically, on the periphery of rotor 4, provided with vanes 15, baffle pieces 16 are then fitted which, in interaction with the vane tips, are able to effect gentle comminution.

Openings 17 in screen 3 are round with a minimum diameter of between 10 mm to 20 mm. Alternatively, the minimum diameter may lie between 2 mm and 5 mm.

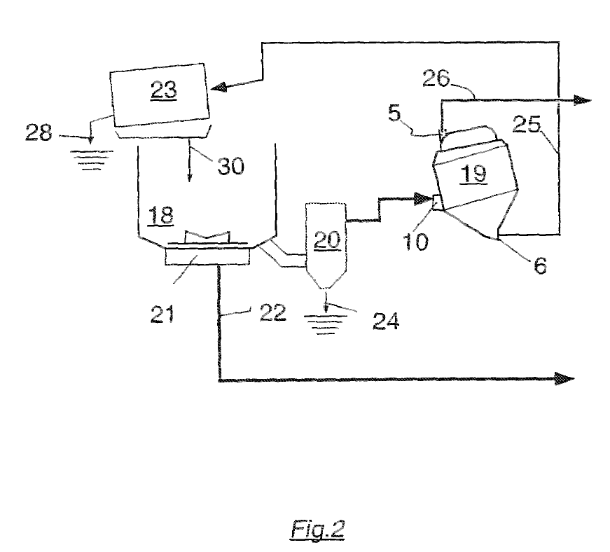

The possible uses of the screening apparatus according to the invention are explained by using a plant example, as illustrated in FIG. 2. Here, the starting point is pulper 18 in which paper stock, for example waste paper, is mixed with water and changed into a suspension. In its bottom region, pulper 18 is equipped with a screen, not shown, through which part of the suspension passes into an annular chamber 21 and is processed further as fibrous suspension 22.

FIG. 2 also shows the extraction of a contaminated fibrous suspension, which has not passed through the screen of pulper 18, through a sedimentation tank 20, and then the forwarding of the suspension freed of coarse heavy fractions 24 in this way into a screening apparatus 19 according to the present invention. Screening apparatus 19 here substantially has the task of pulping the stock further and of separating off a stream 25 of contraries, in order, in this way, to form a clean accepts suspension 26 which has passed through the screen of screening apparatus 19. The stream 25 of contraries passes into a re-sorting apparatus, for example a sorting drum 23, in which a separation between contraries 28 and fibrous suspension 30 is carried out, it being possible, for example, for this fibrous suspension 30 to be led back into pulper 18.

It is to be noted that FIG. 2 is intended to show only one example for the appropriate use of the subject matter of the invention and the possibility of the new apparatus. The diagram illustrates only the most important of the method steps, the apparatuses which are sued for this purpose being only indicated and all of the details of the conveying and regulating devices are not shown.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A screening apparatus for the screening of a contaminated fibrous suspension, the apparatus comprising:
a closed housing having a substantially circular cross section, said housing having a total housing volume;
an inlet connector configured to lead laterally into said housing;
a screen;
a driven rotor movably positioned relative to said screen, said rotor being configured to keep said screen free of blockages, said rotor being rotatable about a first axis;
an accepts chamber that is divided off from said housing by said screen, said accepts chamber having an accepts outlet; and
an outlet line fluidically connected to said housing, said outlet line being configured to pass contraries from the suspension, said housing having a main part rotationally symmetrical about a second axis, said main part having an internal volume of at least 30% of said total housing volume, said first axis being at an oblique angle to said second axis, said angle being between approximately 1° and 60°.

2. The screening apparatus of claim 1, wherein said internal volume of said main part is at least 50% of said total housing volume.

3. The screening apparatus of claim 1, wherein said angle is between 5° and 25°.

4. The screening apparatus of claim 1, further comprising at least one fixing device configured to position said first axis at a β angle from a vertical axis of between 0° and 30°, said screen being arranged above said main part.

5. The screening apparatus of claim 4, wherein said β angle is between 10° and 20°.

6. The screening apparatus of claim 1, wherein said housing further includes an adjoining part between said main part and said screen, said adjoining part widening conically toward said main part, said adjoining part being concentric with said rotor.

7. The screening apparatus of claim 6, wherein said adjoining part is connected to said main part along a transition that is perpendicular to a point on said second axis.

8. The screening apparatus of claim 1, wherein said inlet connector opens into a lower region of said main part.

9. The screening apparatus of claim 1, wherein said housing further includes a narrowing conical part adjoined to said main part.

10. The screening apparatus of claim 9, wherein said outlet line adjoins a lower end of said narrowing conical part.

11. The screening apparatus of claim 1, wherein said main part is positioned a minimum spacing from said rotor, said rotor having a diameter, said minimum spacing not exceeding 50% of said diameter.

12. The screening apparatus of claim 1, wherein said rotor includes a plurality of vanes connected thereto.

13. The screening apparatus of claim 12, wherein said housing further includes a plurality of baffle pieces fixed radially outwardly from said vanes, said baffle pieces and said vanes interacting for comminuting pieces of paper web not yet pulped.

14. The screening apparatus of claim 1, wherein said screen includes a plurality of round openings having a minimum diameter of between 10 mm and 20 mm.

15. The screening apparatus of claim 1, wherein said screen includes a plurality of round openings having a minimum diameter of between 2 mm and 5 mm.

16. A method of processing a waste paper suspension containing contraries, comprising the steps of:
providing a screening apparatus including:
a closed housing having a substantially circular cross section, said housing having a total housing volume;
an inlet connector configured to lead laterally into said housing;
a screen;
a driven rotor movably positioned relative to said screen, said rotor being configured to keep said screen free of blockages, said rotor being rotatable about a first axis;
an accepts chamber that is divided off from said housing by said screen, said accepts chamber having an accepts outlet; and
an outlet line fluidically connected to said housing, said outlet line being configured to pass contraries from the suspension, said housing having a main part rotationally symmetrical about a second axis, said main part having an internal volume of at least 30% of said total housing volume, said first axis being at an oblique angle to said second axis, said angle being between approximately 1° and 60°; and
cleaning the waste paper suspension with said screening apparatus; and
further pulping the waste paper suspension with said screening apparatus.

17. The method of claim 16, further comprising the step of fixing an angle of said first axis relative to a vertical axis, said angle so fixed being between 0° and 30°.
